(19) United States
(12) Patent Application Publication
(10) Pub. No.: US 2004/0080954 A1
(43) Pub. Date: Apr. 29, 2004

(54) Track mount

(76) Inventor: Kenneth D. Eisenbruan, Bloomfield Village, MI (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/457,613

(22) Filed: Jun. 9, 2003

Related U.S. Application Data
(60) Provisional application No. 60/387,774, filed on Jun. 10, 2002.

(51) Int. Cl. F21V 15/04

(52) U.S. Cl. 362/390

(57) ABSTRACT

A track mount for securing an electronic circuit board has an elongated base with two stepped sides extending in opposition therefrom. Each stepped side forms a ledge and a vertical extension. A plurality of periodic catches exists along the vertical extension and are spaced from the ledge to a width at least as great as the width of a circuit board. A circuit board is retained between a catch and the ledge thereby mounted to the track mount. Since the catches are not continuous, a circuit board can be removed without placing undue stress on the track mount structure.

### RELATED APPLICATION

This application claims priority of U.S. Provisional Patent Application Serial No. 60/387,774 filed Jun. 10, 2002, which is incorporated herein by reference.

### FIELD OF THE INVENTION

The present invention relates to track mounting systems for electronic devices and more particularly, to a readily segmented track mount system.

### BACKGROUND OF THE INVENTION

Track mounting systems are commonly used to support a variety of electronic components such as terminals, switches, relays and circuit boards. A typical track is an elongated, rigid metal or plastic track that is affixed to a structure with screws or other fasteners. Tracks are often mounted within cabinets, along walls or on ceilings.

A considerable cost associated with installation of a track is a reinforcement to support the weight in the case of metal track. Additionally, cutting either plastic or metal track to desired lengths dramatically slows installation thereof.

Conventional tracks also have limited usefulness owing to the mode of securement. Conventional DIN (Deutche Industry-Norm) and NEMA (National Electrical Manufacturer's Association) tracks typically have a supported electrical component encompassing opposing rails. An alternate component mounting mode is used in the SNAP Track™ system. SNAP Track™ is an extruded plastic track that has a retaining strip extruded along the full length thereof as shown in prior art FIG. 1. Removing a component from a SNAP Track™ system puts considerable force on the extruded retaining rail and base, thereby leading to fatigue or breakage. Thus, there exists a need for an electrical component track mount that is lightweight, readily sectioned and amenable to electrical component removal.

### SUMMARY OF THE INVENTION

A track mount is disclosed having an elongated base with two stepped sides extending in opposition from the base. Each of the two stepped sides forms a ledge and a vertical extension. Periodic catches are present along the vertical extension and spaced from the ledge. An electronic component, upon being pressed against the track mount, deforms the vertical extension portion and is held in place upon riding past the catches. Absent a continuous strip catch, the present invention allows for component removal absent excessive flexure of the track mount. A track mount preferably has a score line defining a track section that has at least one catch on each of the opposing vertical extensions thereof. Such a score line facilitates sizing track mount for a particular installation.

### BRIEF DESCRIPTION OF THE DRAWINGS

FIG. 1 is a perspective view of a prior art SNAP Track™ 3TK series track;

FIG. 2 is a perspective view of a preferred embodiment of an inventive track mount;

FIG. 3 is a planar view of an alternate embodiment of inventive track mount depicted in FIG. 2 and having an acute angled stepped side; and

FIG. 4 is a planar view of an alternate embodiment of inventive track mount depicted in FIG. 2 and having an obtuse angled stepped side.

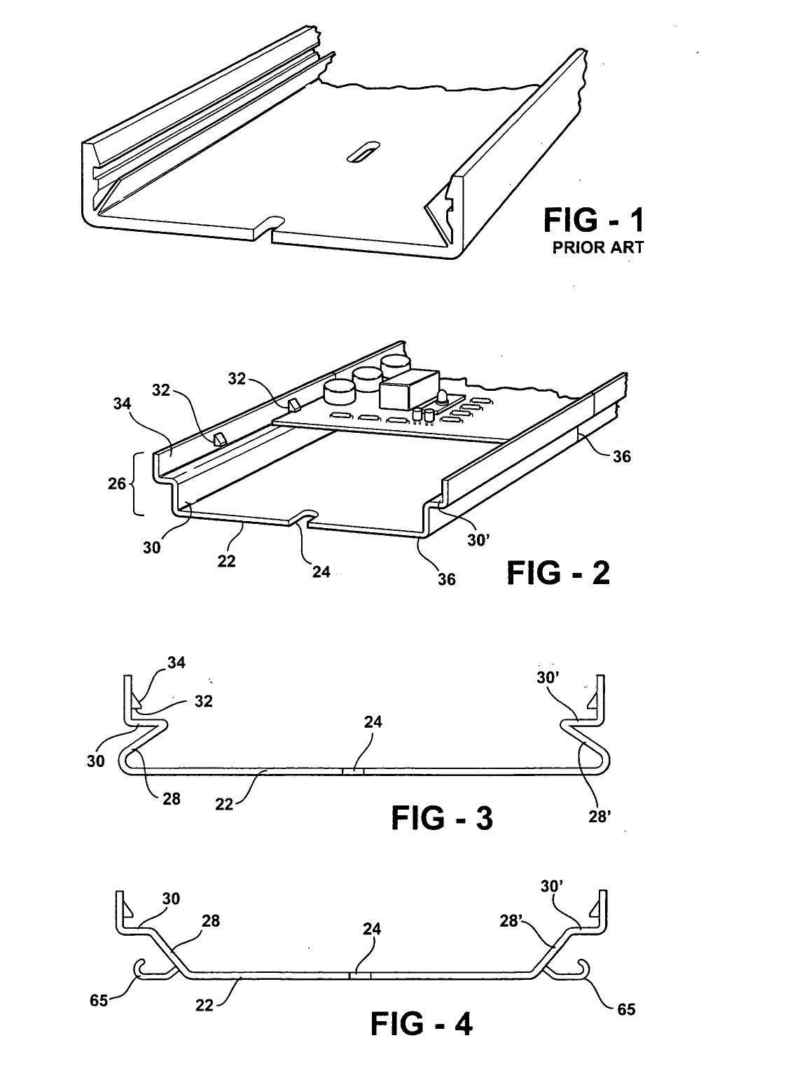

### DESCRIPTION OF THE PREFERRED EMBODIMENT

With respect to FIGS. 2, 3 and 4, the invention is described with respect to one-half of the inventive track mount structure, noting that primed numerals correspond to the opposing like feature on the other side of the inventive track mount.

Referring now to FIG. 2, an inventive track mount is shown generally at 20. The track mount 20 has a generally longitudinal planar base 22. Optionally, apertures 24 periodically punctuate the base 22 to facilitate fixturing of the track mount 20 to a substrate. Preferably, apertures 24 are elongated to afford play after a screw or other fastener has been mounted in contact therewith. A stepped side 26 extends from the base 22 at an angle α. Two stepped sides 26 bound the base 22 and are formed in opposition to one another. A stepped side 26 has a stand-off portion 28 that extends from the base 22 at an angle α. Angle α being between 30° and 150°. The embodiments depicted in FIGS. 3 and 4 vary relative to the embodiment shown in FIG. 2 in having an acute and an obtuse angle α respectively, with like numbers denoting structures as detailed with respect to FIG. 2. Factors relevant in choosing an angle α are the weight loading of the inventive track mount and environmental particulate content. It is appreciated that an acute angle α, while able to bear a larger weight load, is more prone to collect dust and debris than those embodiments where the angle α is approximately 90° or more. Conversely, an obtuse angle α as depicted in FIG. 4, while capable of bearing less weight, has a smaller base footprint relative to the embodiments depicted in FIGS. 2 and 3. A fiber-retaining clip 65 optionally is integrated at periodic intervals into the track mount in order to retain conductive wiring, fiber optics or the like.

The step-off portion 28 of stepped side 26 turns to form a ledge 30. The ledge 30 is intended to support an electronic device (shown in ghost) thereon. The circuit board C is supported above the base 22 between ledges 30 and 30′. A circuit board C is retained in contact with the ledges 30 and 30′ by way of periodical catches 32 integral with a vertical extension 34 of the stepped side 26. The catches 32 are periodically spaced and do not form a continuous rail thereby facilitating removal of a circuit board C from between opposing ledges 30 and 30′. The catches 32 are preferably of a generally triangular shape such that external pressure exerted on opposing catches causes the vertical extensions 34 and 34′ to flex outward and return to the original position only after the circuit board C is in simultaneous engagement with the ledge 30 and the catch 32.

In a preferred embodiment, the inventive track mount 20 has periodic score lines such as that depicted at 36. The score line 36 facilitates sectioning an inventive track mount to a pre-selected size without resort to a miter saw or other cutting instrument. In a more preferred embodiment, each aperture 24 is intersected by a score line 36. Still more preferably, each stepped side 26 includes two catches 32 per side 26 for each segment defined by adjacent score lines 36. A typical segment length is from 2-6 inches in length. Typical spacing between adjacent catches 32 is between one-half and 2 inches.

An inventive track mount is preferably injection molded from a variety of conventional thermoplastic engineering resins as detailed in U.S. Pat. No. 6,357,197. Particularly preferred thermoplastic materials from which to make an inventive track mount include polycarbonate, polyester and acrylonitro-butadyeine-styrene (ABS) materials. This patent is herein incorporated by reference.

The foregoing description is illustrative of particular embodiments of the invention, but is not meant to be a limitation upon the practice thereof. The following claims, including all equivalents thereof, are intended to define the scope of the invention.

1. A track mount comprising:
an elongated base having two stepped sides extending in opposition from said base, each of the two stepped sides forming a ledge and a vertical extension and having a plurality of periodic catches along the vertical extension and spaced from the ledge.

2. The track mount of claim 1, wherein a plurality of periodic apertures punctuate said base.

3. The track mount of claim 2, wherein the periodic apertures are elongated.

4. The track mount of claim 2, wherein at least one of the periodic apertures is intersected by a score line.

5. The track mount of claim 1, wherein adjacent catches of the plurality of periodic catches are spaced from one-half to 2 inches apart.

6. The track mount of claim 1, wherein each of the two stepped sides defines an angle relative to the base of between 30° and 150°.

7. The track mount of claim 6, wherein the angle is between 80° and 120°.

8. The track mount of claim 1, having a plurality of score lines.

9. The track mount of claim 8, wherein there are at least two catches on each opposing vertical extension between adjacent score lines.

10. The track mount of claim 9, wherein adjacent score lines of the plurality of score lines are spaced from 2-6 inches apart.

11. The track mount of claim 1, wherein a fiber-retaining clip extends beneath the ledge and proximal to the base.

12. A track mount comprising:
an elongated base having two stepped sides extending in opposition from said base, each of the two stepped sides forming a ledge and a vertical extension and having a plurality of periodic catches along the vertical extension and spaced from the ledge; and
a score line defining a track section having at least one catch on each of the opposing vertical extensions.

13. The track mount of claim 12, wherein a plurality of periodic apertures punctuate said base.

14. The track mount of claim 13, wherein the periodic apertures are elongated.

15. The track mount of claim 13 wherein said score line intersects one of the plurality of periodic apertures.

16. The track mount of claim 12 wherein there are at least two catches on each of the opposing vertical extensions of said track system.

17. The track mount of claim 12, wherein each of the two stepped sides defines an angle relative to the base of between 30° and 150°.

18. The track mount of claim 17, wherein the angle is between 80° and 120°.
